(19) United States
(12) Patent Application Publication
(10) Pub. No.: US 2012/0273084 A1
(43) Pub. Date: Nov. 1, 2012

(54) STORAGE FILM

(75) Inventors: William P. Belias, Pittsford, NY (US); Seth G. Holmen, Ames, IA (US)

(73) Assignee: AMERICAN PACKAGING CORPORATION, Columbus, WI (US)

(21) Appl. No.: 13/095,121

(22) Filed: Apr. 27, 2011

(51) Int. Cl. F16L 9/14; B32B 37/12; B32B 38/00; B32B 37/02

(52) U.S. Cl. 138/140; 156/192

(57) ABSTRACT

A storage bag for perishable articles includes an unperforated outer layer, an unperforated inner layer, and an intermediate layer disposed between the outer and inner layers. The intermediate layers includes a solventless adhesive mixed with a volatile antimicrobial. In addition, the outer and inner layers are oxygen permeable, and the inner layer has a greater permeability than the outer layer.

The present disclosure relates to a storage film for perishable articles and, in particular, to a multi-layer storage film having a volatile antimicrobial embedded therein.

### BACKGROUND & SUMMARY

Most perishable articles such as produce, meat, seafood, poultry, dairy products, and other food products have only a limited shelf life. For example, at temperatures above approximately 45 degrees Fahrenheit, microbial and/or bacterial spoilage of some perishable articles can begin within a matter of hours, and over the course of several days, such perishable articles may no longer be suitable for sale or consumption. Such limited shelf life can make it difficult for growers and/or producers of such perishable articles to store and/or transport these articles before the onset of spoilage. This limited shelf life may also make it difficult for grocers and other like retail outlets to sell perishable articles once they are received. The relatively short shelf life of such perishable articles frequently results in elevated production and distribution costs, along with an increased likelihood that the articles may not be acceptable to the consumer after sale. In extreme situations, the spoilage of some perishable articles may result in food-borne illnesses, such as botulism and the like.

In an effort to deal with the challenges presented during the storage, transportation, and handling of perishable articles, it may be desirable for the article to interact with one or more antibacterial and/or antimicrobial agents. Such agents may extend the shelf life of such perishable articles by substantially reducing the growth of harmful microbes and/or bacteria. However, known methods and devices for utilizing such agents are not well adapted to regulating and/or otherwise limiting the amount of such agents communicating with the articles. This can be problematic since placing perishable articles in communication with such agents at levels in excess of maximum levels accepted by industry experts may permanently damage the flavor, color, odor, texture, and/or other characteristics of the perishable articles. In addition, some known packaging methods may involve placing the perishable articles in direct contact with such agents. For example, it is common to place one or more cartridges, tablets, packets, or other like carriers in a storage bag, along with the perishable articles. Upon sealing the storage bag, the antimicrobial and/or antibacterial agents may then come into direct contact with the perishable articles during storage. Such contact, however, often causes discoloration, a change in flavor, and other unwanted effects.

Other known methods and structures utilized for perishable article storage may dispose one or more such carriers on the exterior of the storage bag. The user must then puncture the bag and/or otherwise form an orifice in a wall of the bag to enable the agent to pass from the carrier into the portion of the bag where the perishable articles are located. Such storage structures and methods may be undesirable, however, since puncturing a wall of the bag increases the time and effort required to safely store the perishable articles. In addition, while attempting to puncture a wall of the storage bag, the user may cause damage to other portions of the storage bag and/or to the perishable articles themselves, thereby increasing the rate of spoilage and further reducing the shelf life of the perishable articles.

The exemplary embodiments of the present disclosure are aimed at overcoming the problems described above.

In an exemplary embodiment of the present disclosure, a storage bag for perishable articles, includes an unperforated outer layer, an unperforated inner layer, and an intermediate layer disposed between the outer and inner layers. In such an exemplary embodiment, the intermediate layer includes a solventless adhesive mixed with a volatile antimicrobial. In addition, the outer and inner layers are oxygen permeable, and the inner layer has a greater permeability than the outer layer.

In such an exemplary embodiment, the inner layer permits passage of the volatile antimicrobial, in gaseous form, and the outer layer prohibits passage of the volatile antimicrobial. In addition, the antimicrobial is ethyl pyruvate.

In an exemplary embodiment, the intermediate includes between approximately 0.01 percent and approximately 25 percent ethyl pyruvate mixed with between approximately 99.99 percent and approximately 75 percent polyurethane-isocyanate.

In an additional exemplary embodiments, the permeability of the outer layer is between approximately 60 cc/100 in̂2/24 hr and approximately 500 cc/100 in̂2/24 hr at approximately room temperature, and the permeability of the inner layer is between approximately 300 cc/100 in̂2/24 hr and approximately 1000 cc/100 in̂2/24 hr at approximately room temperature.

In another exemplary embodiment, a storage bag for perishable articles includes an unperforated first wall, and an unperforated second wall sealed to the first wall and defining a resealable closure with the first wall along a length thereof. The first and second walls form a storage compartment therebetween, and permit passage of a gaseous volatile antimicrobial into the storage compartment.

In such an exemplary embodiment, the volatile antimicrobial passes into the storage compartment from within at least one of the first and second walls, and the volatile antimicrobial is stored between separate layers of at least one of the first and second walls. In such an exemplary embodiment, the volatile antimicrobial is embedded, in liquid form, within a porous mineral, and the mixture of volatile antimicrobial and porous mineral is stored between layers of at lease one of the first and second walls. In another exemplary embodiment, the volatile antimicrobial is mixed with a solventless adhesive and the mixture is stored between layers of at least one of the first and second walls. In another exemplary embodiment, passage of the volatile antimicrobial into the storage compartment forms a desired atmosphere within the storage compartment.

In an additional exemplary embodiment, the desired atmosphere includes between approximately 100 ppm and approximately 1000 ppm of the volatile antimicrobial. In such an exemplary embodiment, desired atmosphere within the storage compartment is formed at a vapor pressure between approximately 0.01 atm and approximately 0.20 atm.

In further exemplary embodiments, an outer layer of at least one of the first and second walls prohibits passage of the volatile antimicrobial and an inner layer of the at least one wall permits passage of the volatile antimicrobial. In addition, the first and second walls are adapted to permit passage of the gaseous volatile antimicrobial into the storage compartment at temperatures between approximately room temperature and approximately 30 degrees Fahrenheit, and a rate of passage of the volatile antimicrobial into the storage compartment increases as a temperature within the storage compartment increases. Moreover, a concentration of the volatile antimicrobial within the storage compartment increases in response to an increase in a temperature within the storage compartment.

In a further exemplary embodiment of the present disclosure, a storage film includes an unperforated outer layer, an unperforated inner layer having a greater permeability than the outer layer, and an intermediate layer connecting the outer and inner layer. The intermediate layer includes an adhesive mixed with a volatile antimicrobial, and the film is wound to form a roll. The outer layer substantially prohibits passage of the volatile antimicrobial from the roll. In such an exemplary embodiment, unwinding the roll enables the volatile antimicrobial to pass from the intermediate layer through the inner layer.

In still another exemplary embodiment of the present disclosure, a method of manufacturing a storage film includes adhering an unperforated outer layer to an unperforated inner layer using an intermediate layer disposed between the inner and outer layer. The intermediate layer includes an adhesive mixed with a volatile antimicrobial. Such an exemplary method also includes winding the adhered outer and inner layer to form a roll of the storage film. The outer layer substantially prohibits passage of the volatile antimicrobial from the roll.

### BRIEF DESCRIPTION OF THE DRAWING(S)

The accompanying figures, in which like reference numerals refer to similar elements throughout the separate views, further illustrate the embodiments and, together with the detailed description, serve to explain the embodiments disclosed herein. It is also noted that the drawings may not have been drawn to scale and that certain regions may have been purposely drawn disproportionately so that depicted features and concepts could be properly illustrated. The drawings are for purposes of illustrating various embodiments and are not to be construed as limiting, wherein:

FIG. 1 illustrates a cross-sectional view of a storage film according to an exemplary embodiment of the present disclosure;

FIG. 2 illustrates a roll of storage film according to an exemplary embodiment of the present disclosure;

FIG. 3 illustrates a storage bag according to an exemplary embodiment of the present disclosure; and

FIG. 4 is a cross-sectional view of the storage bag shown in FIG. 3.

### DETAILED DESCRIPTION

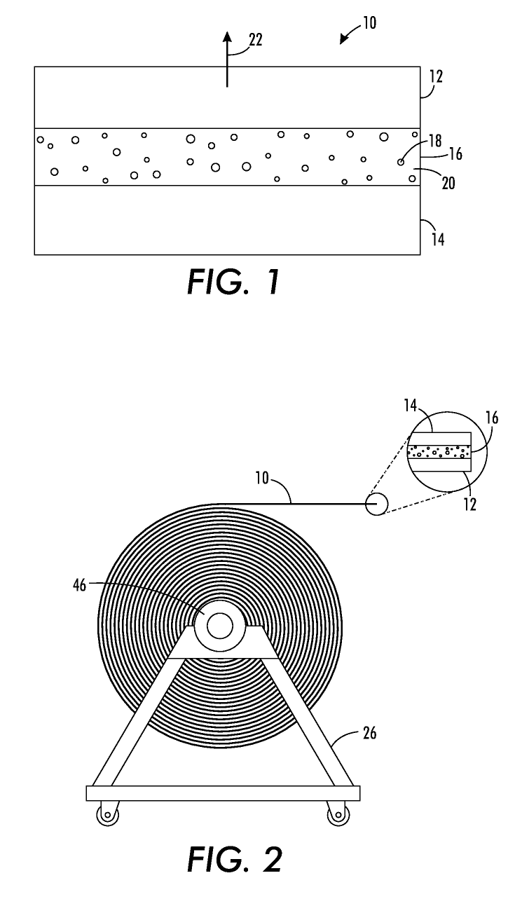

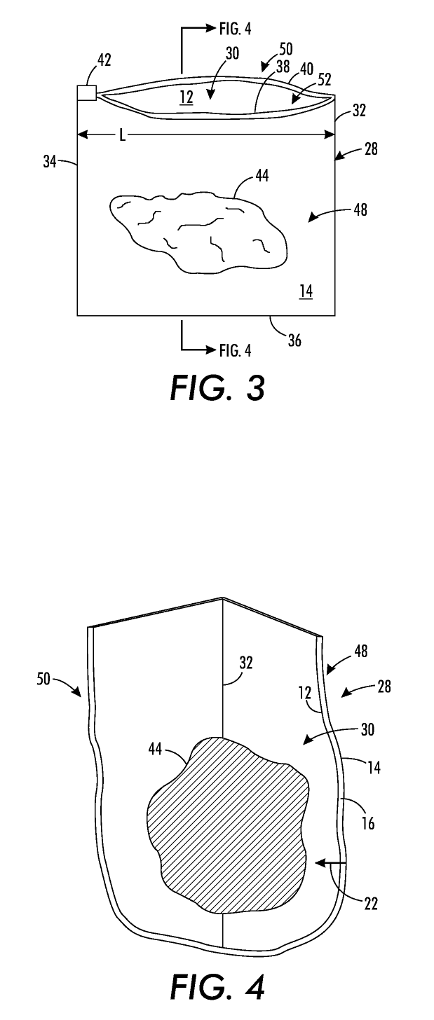

FIG. 1 illustrates a storage film 10 according to an exemplary embodiment of the present disclosure. The storage film 10 may be made from a single layer of plastic and/or polymeric material. Such materials may include, for example, polyethylene, polypropylene, polyolefin, polyamide, polyester, and/or any other like materials commonly used for handling, storage, and/or transportation of perishable articles. In an exemplary embodiment, the storage film 10 may include more than one layer, contacting, overlaying, adhered to, and/or otherwise connected to each other by any known means. In an exemplary embodiment, such multiple layers may be co-extruded, such that the storage film 10 is formed with multiple layers. In additional exemplary embodiments, the one or more layers may be formed separately and later combined to form the storage film 10. The storage film 10 may include any number of layers in order to impart desirable characteristics to the storage film 10. For example, the various layers of the storage film 10 may have different levels of permeability, transparency, strength, elasticity, and/or other characteristics, and the combined characteristics of such layers may result in a storage film 10 that is tailored toward a specific perishable article storage and/or handling application. One such application may be as produce bags, such as storage bags (e.g., FIG. 3) for perishable precut salad or prewashed vegetables.

As shown in FIG. 1, in an exemplary embodiment, the storage film 10 may include an inner layer 12, an outer layer 14, and an intermediate layer 16. The intermediate layer 16 may be disposed between the outer layer 14 and the inner layer 12, and in an exemplary embodiment, the intermediate layer 16 may adhere, join, bind, and/or otherwise connect the outer layer 14 and the inner layer 12. The inner and outer layer 12, 14 may be substantially structurally similar. For example, the inner and outer layer 12, 14 may have substantially the same shape, size, dimensions, and/or other configurations. In an exemplary embodiment, the inner and outer layer 12, 14 may have substantially the same thickness. In an exemplary embodiment, the inner and outer layer 12, 14 may have a thickness between, approximately 12 micron and approximately 200 micron. In additional exemplary embodiments, the outer layer 14 may be formed from a substantially non-permeable polymer such as, for example, oriented polypropylene, polystyrene, polyester and/or other like materials. The inner and outer layer 12, 14 may be formed from any of the plastics, polymers, and/or other materials described above. In an exemplary embodiment, the inner layer 12 may be formed from a material such as, for example, polyethylene, polypropylene, polystyrene or other materials that are at least partially permeable to gasses. In such an exemplary embodiment, the outer layer 14 may function as a barrier layer prohibiting passage of liquids and/or gasses therethrough. Thus, in an exemplary embodiment in which the outer layer 14 has been combined with and/or otherwise connected to the inner layer 12, the resulting storage film 10 may permit passage of materials in the liquid and/or gas phase in any desirable direction relative to the one or more surfaces of the storage film 10.

For example, in an embodiment in which the inner layer 12 has a greater permeability than the outer layer 14, liquids and/or gasses may be permitted to pass in the direction of arrow 22. In such an exemplary embodiment, elements of a desired size and/or phase may be permitted to pass through both the inner and outer layer 12, 14, while the difference in permeability of the layers 12, 14 may prohibit passage of such materials in a direction opposite the arrow 22. For example, in embodiments in which the storage film 10 is utilized in the packaging, storing, and/or transportation of perishable articles, the inner and outer layer 12, 14 may be permeable to oxygen and/or other like elements. In addition, in such exemplary embodiments, the difference in permeability between the inner layer 12 and the outer layer 14 may be such that desired elements are permitted to pass through the inner layer 12 but are prohibited from passing through the outer layer 14. Such elements may be, for example, disposed between the inner and outer layer 12, 14. In an exemplary embodiment, such elements may be embedded and/or otherwise disposed within the intermediate layer 16. It is understood that the inner and outer layer 12, 14 may comprise substantially solid, one-piece, unperforated sheets of material. Alternatively, in additional exemplary embodiments, at least one of the layers 12, 14 of the storage film 10 may include microperforations and/or other structures assisting in the permeability thereof.

The intermediate layer 16 may comprise any combination of additives, binders, cross-linking agents, adhesives, antimicrobial agents, antibacterial agents, flavors, fragrances, colorants, antioxidants, odor absorbents, chelating agents, and/or other like materials. In an exemplary embodiment, the intermediate layer 16 may comprise a solventless adhesive 20, and one or more components such as, for example, antimicrobial and/or antibacterial agents may be interspersed therein and/or otherwise mixed therewith. In an exemplary embodiment, the intermediate layer 16 may comprise a solventless adhesive 20 mixed with a volatile antimicrobial 18. Such a solventless adhesive 20 may be, for example, a urethane adhesive such asisocyanate crosslinked poly-urethane, and such volatile antimicrobials may include, for example d-lymonene, and ethyl pyruvate. The inner layer 12 may permit passage of the volatile antimicrobial 18, in gaseous form, in the direction of arrow 22. In such an exemplary embodiment, the outer layer 14 may prohibit passage of the volatile antimicrobial 18. Thus, in such an exemplary embodiment, the outer layer 14 may act as a barrier layer, and the storage film 10 may only permit passage of, for example, the volatile antimicrobial 18 in the direction of arrow 22.

In an exemplary embodiment, the intermediate layer 16 may comprise between approximately 0.01% and approximately 10% ethyl pyruvate and/or other like volatile antimicrobials 18. In such an exemplary embodiment, the intermediate layer 16 may also comprise between approximately 99.999% and approximately 90% polyurethane-isocyanate or other like adhesives 20. It is understood, however, that such relative compositions of the intermediate layer 16 are merely exemplary, and that in additional exemplary embodiments, the percentage of volatile antimicrobial 18 may be greater than approximately 10% while the corresponding percentage of adhesive 20 may be less than approximately 90%.

In addition, the inner and outer layer 12, 14 may have any desirable range of permeabilities known in the art to facilitate the desired rate and/or volume of volatile antimicrobial 18 transmitted and/or otherwise passed through the inner layer 12. For example, the permeability of the outer layer 14 may be between approximately 100 cc/100 in̂2/24 hr and approximately 500 cc/100 in̂2/24 hr at approximately room temperature. In addition, in an exemplary embodiment, the permeability of the inner layer may be between approximately 400 cc/100 in̂2/24 hr and approximately 1000 cc/100 in̂2/24 hr at approximately room temperature. It is further understood that the above ranges are merely approximations, and that the relative permeability of the inner and outer layer 12, 14 may be increased and/or decreased in order to provide enhanced and/or otherwise desired permeability characteristics of the storage film 10. It is further understood that as the temperature, pressure, humidity, vapor pressure, and/or other environmental parameters in which the storage film 10 is used are altered, the permeability ranges discussed above may correspondingly increase and/or decrease. For example, as the temperature of the ambient environment surrounding the storage film 10 increases, the rate of passage of the volatile antimicrobial 18 through the inner layer 12 in the direction of arrow 22 also increases. In exemplary embodiments in which the storage film 10 is utilized to form a storage bag or similar flexible container of the present disclosure, an increase in the temperature within the storage bag may also result in an increased rate of passage of the volatile antimicrobial 18 through the inner layer 12 and into the bag.

The exemplary storage film 10 described herein may be manufactured through any number of known film manufacturing processes such as extrusion, lamination, molding, and the like. Such processes may be useful in forming extended sheets of the storage film 10 that can be folded, rolled, and/or otherwise manipulated in any convenient way for long-term storage thereof. For example, in a blown film extrusion and/or other like extrusion process, the inner layer 12 may be formed separate from the outer layer 14. Each separate layer may then be disposed on separate spindles or other like structures to form separate rolls of each layer 12, 14. An intermediate layer 16 of the type described above may then be applied to either or both such separate layers, and the separate layers may then be adhered and/or otherwise connected to each other via the intermediate layer 16 disposed thereon and/or therebetween. In such an exemplary embodiment, the intermediate layer 16 may be disposed on at least one of the inner and outer layer 12, 14 by any known method such as, for example, spraying, rolling, and the like. In additional exemplary embodiments, the intermediate layer 16 may be applied to at least one of the inner and outer layer 12, 14 during, for example, the extrusion and/or other manufacturing processes utilized to form the inner and outer layer 12, 14. In such exemplary manufacturing embodiments, the storage film 10 may be formed through a single streamlined process in which the inner and outer layer 12, 14 are adhered, molded, and/or otherwise connected to each other upon and/or immediately following extrusion and/or cooling thereof.

In still further exemplary embodiments, the intermediate layer 16 may be formed independently of the inner and outer layer 12, 14 by mixing a cross-linking agent with a solventless adhesive. Exemplary cross-linking agents may include, for example, isocyanate, malose, glyoxal, dicarboxylic acid, and/or any other known cross-linking agents. In such exemplary embodiments, the use of a solventless adhesive may eliminate the requirement for heating and/or drying the mixture. Accordingly, in producing the intermediate layer 16, the volatile antimicrobial 18 may be added to a relatively cool and/or room temperature mixture of adhesive and cross-linking agent. It may be advantageous to mix the volatile antimicrobial 18 with the cross-linking agent/adhesive mixture at such relatively low temperatures so as to avoid cooking and/or otherwise flashing-off the volatile antimicrobial 18 during such a mixing process. Once the volatile antimicrobial 18 has been sufficiently dispersed throughout and/or otherwise mixed with the cross-linking agent/adhesive mixture, this composition may then be applied to the inner layer 12 and/or the outer layer 14 thus forming the intermediate layer 16 of the storage film 10.

As mentioned above, one or more additional layers may be included in the storage film 10. Such layers may include additional layers comprising additional additives, binders, primers, adhesion enhancing agents, cross-linking agents, antimicrobial agents, antibacterial agents and/or other like materials. Such layers may be disposed between the inner and outer layer 12, 14 so as to provide additional desired functionality to the storage film 10. In addition, the storage film 10 may comprise any number of additional layers of plastic, polymer, and/or other like materials. Such exemplary additional layers may be similar in structure and/or configuration to the inner and outer layer 12, 14, and such layers may assist in improving the strength, flexibility, moisture barrier properties, and/or other desired characteristics of the storage film 10.

As shown in FIG. 2, once the storage film 10 has been manufactured via any of the processes described herein, the storage film 10 may be wound to form a roll 24 of the storage film 10. For example, the storage film 10 may be wound onto a spindle 46 that is substantially cylindrical in nature. The spindle 46 may be sufficiently structurally robust so as to support the weight of the roll 24 during winding, unwinding, transportation, storage, and/or other typical manufacturing and/or handling processes. For example, the spindle 46 may be of any desired length so as to extend beyond the width of the roll 24, such that the entire width of the roll 24 may be supported by the spindle 46. The spindle 46 may further include any number of sufficiently situated structures or components to facilitate easy winding and unwinding of the storage film 10. Such structures and/or components may include, for example, rollers, bearings, shoulders, fittings, flats, and the like.

The spindle 46 may be configured to be disposed on one or more carts 26 designed to transport the roll 24 between different locations within, for example, a storage film manufacturing facility. It is understood that once the roll 24 has been disposed on the spindle 46, and the spindle 46 has been disposed on the cart 26, the roll 24 of storage film 10 may be stored on the cart 26 or on other like manufacturing facility equipment for extended periods of time. Accordingly, it may be beneficial to wind the storage film 10 in a desired direction around the spindle 46 in order to prevent the evaporation and/or escape of, for example, the volatile antimicrobial 18. For example, it may be desirable to wind the storage film 10 on the spindle 46 such that the outer layer 14 is disposed on the outside of the roll 24, as shown in FIG. 2. By winding the storage film 10 in this way, the outer layer 14 may substantially prohibit, for example, the volatile antimicrobial 18 from escaping while the roll 24 is in storage. Thus, such a manufacturing and winding methodology may assist in extending the shelf life, antimicrobial characteristics, and/or antibacterial characteristics of the storage film 10 itself.

To further assist in preventing the escape of the volatile antimicrobial 18 during storage of the storage film 10, each individual roll 24 of the storage film 10 may be wrapped and/or otherwise covered with a barrier film similar to the outer layer 14 described herein. Such additional wrapping may further assist in extending the usable life of the storage film 10. It is understood that during use, unwinding the roll 24 of the storage film 10 may cause the inner layer 12 to be exposed to the ambient environment. Such exposure may enable the volatile antimicrobial 18 to pass from the intermediate layer 16 through the inner layer 12. Accordingly, preferable manufacturing processes may minimize and/or substantially eliminate the length of time in which the inner layer 12 is so exposed. For example, preferable manufacturing and/or storage bag formation processes may rapidly fold the storage film 10 upon unwinding the roll 24. In such processes, the inner layer 12 of the storage film 10 may be folded onto itself thereby substantially eliminating its exposure to the ambient environment during processing.

For example, as described herein, the storage film 10 may be utilized to form a storage bag of any kind, and such storage bags may be useful for storing and/or extending the useful shelf life of perishable articles. As described above, such perishable articles may include any type of food products such as, for example, meat, poultry, fish, produce, and other like articles. FIG. 3 illustrates an exemplary storage bag 28 of the present disclosure within which a perishable article 44 has been disposed.

As shown in FIG. 3, such an exemplary storage bag 28 may include the unperforated inner and outer layer 12, 14 described above. In forming such a storage bag 28, the storage film 10 may be folded and/or otherwise manipulated such that the outer layer 14 forms an outer portion or surface of the storage bag 28, and the inner layer 12 assists in forming a storage compartment 30 within the storage bag 28. The storage compartment 30 may be shaped, sized, and/or otherwise configured to assist in storing the perishable article 44. The storage bag 28 may include one or more gussets, folds, extensions, tabs, handles, and/or other like structures configured to assist in handling and/or transporting the bag 28. Such structures may also assist in increasing the overall volume of the storage bag 28 while only moderately increasing the size and/or footprint of the bag 28. Although the storage bag 28 is illustrated as being substantially square, in further exemplary embodiments, the storage bag 28 may be substantially rectangular, substantially circular, substantially oblong, and/or any other convenient size, shape, and/or configuration for storing different types of perishable articles 44.

In an exemplary embodiment, the storage bag 28 may be formed by any conventional bag formation process. For example, the storage film 10 may be folded to form a substantially linear base 36 of the storage bag 28. The folded storage film 10 may then be passed through any of a number of common bag manufacturing and/or assembly devices, at least one of which may assist in forming one or more seals 32, 34 along the sides of the bag 28. For example, in forming the seals 32, 34, portions of the storage film 10 may be heated to a temperature sufficient to sever the storage film 10 and effectively bind and/or otherwise seal the sides of the storage bag 28. Thus, through such a process, separate storage bags 28 may be formed from a substantially one-piece sheet of the storage film 10.

The storage bag 28 may also include a resealable closure 52 extending along a length L of the storage bag 28. Such a resealable closure 52 may be configured to desirably connect and/or disconnect a first wall 48 of the storage bag 28 with a second wall 50 thereof, along the length L. The resealable closure 52 may have any known configuration effective for forming a substantially water-tight seal between the walls 48,50 of the storage bag 28, opposite the base 26 thereof. The closure 52 may include any number of known components to facilitate forming such a releasable seal. Such components may include, for example, known zippers, communicating meshing portions, and the like.

As shown in FIG. 3, in an exemplary embodiment, the resealable closure 52 may include closure strips 38,40 joined to the first and second wall 48,50, respectively. Such closure strips 38,40 may include any number of corresponding teeth, grooves, shoulders, tongues, notches, channels, extensions, and/or other like structures configured to assist in releasably sealing the top of the storage bag 28, thereby permitting and/or prohibiting access to the storage compartment 30. The resealable closure 52 may further include one or more closure devices 42 to assist in connecting and/or disconnecting the closure strips 38, 40. Such common closure devices 42 may comprise any of a number of guides, sliders, or other like components configured to join the closure strips 38, 40 when the closure device 42 is moved in a first direction along the length L, and to detach the closure strips 38,40 when moved in an opposite direction along the length L.

In additional exemplary embodiments, the closure strips 38, 40 may be configured to be connected and disconnected by hand, and in such exemplary embodiments, the closure device 42 may be omitted. In still further exemplary embodiments, it may be desirable to store the perishable article 44 within the storage compartment 30 for extended periods of time without opening the resealable closure 52. In such exemplary embodiments, the resealable closure 52 may be omitted, and instead, a seal similar to the seals 32, 34 described above may be formed along the length L of the storage bag 28 opposite the base 36. In such exemplary embodiments, the perishable article 44 may be vacuum-sealed within the storage compartment 30, and the storage bag 28 may be sealed along the length L in a manner effectively maintaining such a vacuum within a storage compartment 30. In each of the exemplary embodiments described herein, the first and second walls 48, 50 may form the storage compartment 30 therebetween, and the walls 48, 50 may be configured to permit passage of the volatile antimicrobial 18 into the storage compartment 30 to assist in, for example, reducing and/or substantially eliminating spoilage of the perishable article 44 due to mold and/or bacteria formation.

With reference to FIG. 4, the volatile antimicrobial 18 (not shown) may pass into the storage compartment 30 from within at least one of the first and second walls 48,50, in the direction of arrow 22. As described above, the volatile antimicrobial 18 may be stored between the separate inner and outer layer 12,14 of the respective first and second walls 48,50. In further exemplary embodiments, the volatile antimicrobial 18 may be embedded, while in liquid form, within one or more porous minerals or other materials such as diatomaceous earth or clay. This mixture of volatile antimicrobial 18 and porous material may then be mixed with any of the adhesives 20 described above in forming the compound used for the intermediate layer 16. Accordingly, such a mixture may be stored between the layers 12,14 of at least one of the first and second walls 48,50 in a manner similar to the intermediate layer formation procedures described above. Once the resealable closure 52 is substantially closed and the storage compartment 30 is substantially fluidly sealed from the ambient environment, passage of the volatile antimicrobial 18 into the storage compartment 30 may form any desired atmosphere within the storage compartment 30 so as to extend the shelf life of the perishable article 44. For example, such desired atmospheres may include between approximately 100 ppm and approximately 1,000 ppm of the volatile antimicrobial 18 within the storage compartment 30. It is understood that the vapor pressure, temperature, and/or other environmental factors within the storage compartment 30 may affect the passage of the volatile antimicrobial 18 into the storage compartment 30.

In a first exemplary embodiment, the humidity level within the storage compartment 30 may have no effect on the release rate of the volatile antimicrobial 18 into the storage compartment 30. However, in additional exemplary embodiments, as the humidity within the storage compartment 30 increases, the release rate of the volatile antimicrobial 18 into the storage compartment 30 may correspondingly increase. In such exemplary embodiments, when the humidity within the storage compartment 30 is equal to approximately zero percent (dry conditions), substantially no volatile antimicrobial 18 may pass through the inner layer 12 into the storage compartment 30.

In exemplary embodiments of the storage bag 28, the desired atmosphere within the storage compartment 30 may be formed at a vapor pressure between approximately 0.01 atm and approximately 0.20 atm. In addition, as the temperature within the storage compartment 30 increases, the release rate of the volatile antimicrobial 18 into the storage compartment 30 may also correspondingly increase. In some exemplary embodiments, the release rate of the volatile antimicrobial 18 through the inner layer 12 may increase until a desired equilibrium within the storage compartment 30 is reached. For example, the layers 12,14,16 and other components of the storage bag 28 may be specifically designed, chosen, and/or tailored to increase the passage rate and/or volume of the volatile antimicrobial 18 passed into the storage compartment 30 in response to an increased demand or need for the volatile antimicrobial 18 within the storage compartment 30. Such increased need or demand may be caused by an increase in, for example, mold and/or bacterial growth, and such increased growth may result from an increase in temperature and/or humidity within the storage compartment 30. Accordingly, the storage bag 28 and its individual layers 12,14,16 may be designed to automatically match the level of antimicrobial treatment to the demand within the storage compartment 30.

In any of the exemplary embodiments described herein, as the concentration of volatile antimicrobial 18 within the storage compartment 30 increases, the release rate of the volatile antimicrobial 18 through the inner layer 12 may exhibit a corresponding decrease. Conversely, as the volatile antimicrobial 18 is consumed within the storage compartment 30 through various antimicrobial, antibacterial, and other growth inhibition processes, additional volatile antimicrobial 18 may be released into the storage compartment 30 to assist in maintaining the temperature dependent vapor level within the storage compartment 30. In addition, because the volatile antimicrobial 18 is passed into the storage compartment 30 in the gas phase, the perishable article 44 may be substantially surrounded by the volatile antimicrobial 18 without suffering from the adverse effects commonly observed when such perishable articles 44 are placed into direct contact with like antimicrobial, antibacterial, and/or other agents in the solid or liquid phase.

In exemplary embodiments, the perishable article 44 may be stored within the storage bag 28 at temperatures close to freezing in order to assist in extending shelf life and inhibiting spoilage. It is understood that the first and second walls 48,50 may be adapted to permit passage of the gaseous volatile antimicrobial 18 into the storage compartment 30 at temperatures above approximately 30 degrees Fahrenheit. For example, the walls 48,50 may be adapted to create passage of the gaseous volatile antimicrobial 18 into the storage compartment 30 at temperatures between approximately 30° and approximately room temperature or higher.

It will be appreciated that several of the above-disclosed embodiments and other features and functions, or alternatives thereof, may be desirably combined into many other different systems or applications. The presently disclosed embodiments are, therefore, considered in all respects to be illustrative and not restrictive. The scope of the appended claims, and all changes that come within the meaning and range of equivalents thereof are intended to be embraced therein. Also, various presently unforeseen or unanticipated alternatives, modifications, variations or improvements therein may be subsequently made by those skilled in the art which are also intended to be encompassed by the description above and the following claims.

What is claimed is:

1. A storage bag for perishable articles, comprising:
(a) an unperforated outer layer;
(b) an unperforated inner layer; and
(c) an intermediate layer disposed between the outer and inner layers, the intermediate layer comprising a solventless adhesive mixed with a volatile antimicrobial, the outer and inner layers being oxygen permeable, and the inner layer having a greater permeability than the outer layer.

2. The storage bag of claim 1, wherein the inner layer permits passage of the volatile antimicrobial, in gaseous form, and the outer layer prohibits passage of the volatile antimicrobial.

3. The storage bag of claim 1, wherein the volatile antimicrobial comprises ethyl pyruvate.

4. The storage bag of claim 1, wherein the intermediate layer comprises between approximately 0.01 percent and approximately 10 percent ethyl pyruvate mixed with between approximately 99.99 percent and approximately 90 percent polyurethane-isocyanate.

5. The storage bag of claim 1, wherein the permeability of the outer layer is between approximately 100 cc/100 in̂2/24 hr and approximately 500 cc/100 in̂2/24 hr at approximately room temperature, and the permeability of the inner layer is between approximately 400 cc/100 in̂2/24 hr and approximately 1000 cc/100 in̂2/24 hr at approximately room temperature.

6. A storage bag for perishable articles, comprising:
(a) an unperforated first wall;
(b) an unperforated second wall sealed to the first wall and defining a resealable closure with the first wall along a length thereof; and
(c) the first and second walls forming a storage compartment therebetween, and permitting passage of a gaseous volatile antimicrobial into the storage compartment.

7. The storage bag of claim 6, wherein the volatile antimicrobial passes into the storage compartment from within at least one of the first and second walls.

8. The storage bag of claim 6, wherein the volatile antimicrobial is stored between separate layers of at least one of the first and second walls.

9. The storage bag of claim 6, wherein the volatile antimicrobial is embedded, in liquid form, within a porous mineral, and
(a) the mixture of volatile antimicrobial and porous mineral is stored between layers of at least one of the first and second walls.

10. The storage bag of claim 6, wherein the volatile antimicrobial is mixed with a solventless adhesive and the mixture is stored between layers of at least one of the first and second walls.

11. The storage bag of claim 6, wherein passage of the volatile antimicrobial into the storage compartment forms a desired atmosphere within the storage compartment comprising between approximately 100 ppm and approximately 1000 ppm of the volatile antimicrobial.

12. The storage bag of claim 11, wherein the desired atmosphere within the storage compartment is formed at a vapor pressure between approximately 0.01 atm and approximately 0.20 atm.

13. The storage bag of claim 6, wherein an outer layer of at least one of the first and second walls prohibits passage of the volatile antimicrobial and an inner layer of the at least one wall permits passage of the volatile antimicrobial.

14. The storage bag of claim 6, wherein the first and second walls are adapted to permit passage of the gaseous volatile antimicrobial into the storage compartment at temperatures between approximately room temperature and approximately 30 degrees Fahrenheit.

15. The storage bag of claim 6, wherein a rate of passage of the volatile antimicrobial into the storage compartment increases as a temperature within the storage compartment increases.

16. The storage bag of claim 6, wherein a concentration of the volatile antimicrobial within the storage compartment increases in response to an increase in a temperature within the storage compartment.

17. A storage film, comprising:
(a) an unperforated outer layer;
(b) an unperforated inner layer having a greater permeability than the outer layer;
(c) an intermediate layer connecting the outer and inner layer, the intermediate layer comprising an adhesive mixed with a volatile antimicrobial; and
(d) the film being wound to form a roll and the outer layer substantially prohibiting passage of the volatile antimicrobial from the roll.

18. The storage film of claim 17, wherein unwinding the roll enables the volatile antimicrobial to pass from the intermediate layer through the inner layer.

19. A method of manufacturing a storage film, comprising:
(a) adhering an unperforated outer layer to an unperforated inner layer using an intermediate layer disposed between the inner and outer layer, the intermediate layer comprising an adhesive mixed with a volatile antimicrobial; and
(b) winding the adhered outer and inner layer to form a roll of the storage film, the outer layer substantially prohibiting passage of the volatile antimicrobial from the roll.
